(19) United States
(12) Patent Application Publication
(10) Pub. No.: US 2006/0023265 A1
(43) Pub. Date: Feb. 2, 2006

(54) Scanner and method of controlling a position of a scanning unit

(76) Inventor: Yeo-phil Yoon, Hwaseong-si (KR)

Correspondence Address: STANZIONE & KIM, LLP, 919 18TH STREET, N.W., SUITE 440, WASHINGTON, DC, 20006, US

(21) Appl. No.: 11/185,762

(22) Filed: Jul. 21, 2005

(30) Foreign Application Priority Data
Jul. 29, 2004 (KR) 2004-59553

(51) Int. Cl. H04N 1/04

(52) U.S. Cl. 358/474

(57) ABSTRACT

A scanner and a method of controlling a position of a scanning unit. The scanner includes: a flat-plate glass having a pattern display in a scanning area thereof, a carriage mounted with a scanning unit to generate an image data by reading the scanning area, an actuator to drive the carriage, a position calculating unit to determine image data that corresponds to the pattern display and to calculate properties of the image data that corresponds to the pattern display, and a control unit to distinguish the image data that corresponds to the pattern display from among the generated image data for the scanning area, to calculate a position of the scanning unit according to the image data that corresponds to the pattern display, and to control the actuator according to the calculated position. As such, the scanner makes it possible to achieve precise position control on the scanning unit by finding a present position of the scanning unit with the aid of the pattern display, and by moving the scanning unit to an appropriate position for a subsequent scanning process.

### CROSS-REFERENCE TO RELATED APPLICATIONS

This application claims the benefit under 35 U.S.C. § 119 of Korean Patent Application No. 2004-59553, filed on Jul. 29, 2004, the entire content of which is incorporated herein by reference.

### BACKGROUND OF THE INVENTION

1. Field of the Invention

The present general inventive concept relates in general to a scanner and a scanning unit, and more particularly, to a scanner that is capable of calculating a present position of a scanning unit and transferring the scanning unit to a desired scanning position. The present general inventive concept also relates to a method of controlling the position of the scanning unit.

2. Description of the Related Art

In general, a scanner is a device that irradiates an object to be scanned, such as text or illustrations that are printed on a paper, and photoelectrically converts an optical image to digital image data that is comprehensible by a computer. Scanners can be categorized as sheet feed scanners, in which a scanning unit is fixed whereas the object to be scanned (e.g., a document) itself is moved, and flat bed scanners, in which a user places the object to be scanned on a glass and a scanning unit moves under the glass to scan the object.

The scanning unit of the flat bed scanner includes an image sensor such as a CCD (Charge-Coupled Device), which is loaded on a carriage on a lower side of a flat-plate glass, and moves back and forth to scan and read each line of the document. The carriage is driven by a timing belt and a drive motor via a carriage shaft disposed on the carriage.

As aforementioned, in the flat bed scanner the scanning unit moves back and forth to scan the document. A conventional method of determining a position of the scanning unit uses a reference position called ‘home’ to locate the position of the scanning unit, after every movement thereof.

When the carriage moves with the scanning unit, a control unit can typically only determine a relative position of the carriage and can not determine an absolute position thereof. Therefore, it becomes necessary to check the reference position for every movement of the scanning unit at a time when a system to which the scanner is connected is initialized. In order to secure the home position (i.e., the reference position), the object positioned exactly on the scanner and a home sensor of the carriage are constructed to move together. Therefore, by using the home position during a scanning process as the reference position, it becomes possible to locate the scanning unit.

In other words, in order to determine the position of the scanning unit in the flat bed scanner, a number of pulses of the drive motor that drives the scanning unit are counted and the relative position from the home position is calculated. Every time a new scanning process is performed, the scanning unit is required to move back to the home position. When the system having the scanner restarts after the system had been stopped, the scanning unit is moved toward the home position, and the home sensor senses the scanning unit, or the movement of the scanning unit. The sensed signal is then input to the control unit, and the control unit eventually stops the movement of the scanning unit at the home position.

The above-described conventional method of locating the scanning unit by finding a distance from the home position is entirely dependent on counting the number of pulses of the drive motor. Thus, there are many factors that could introduce error, for example, a number of pulses of the driving motor that are inaccurately counted, a change in speed of the movement of the scanning unit, inaccuracy of performance of the home sensor, and inaccurate control by the control unit.

In particular, when there is an error produced by the home sensor, it becomes very difficult to find a precise position of the home position. For instance, when the home sensor fails, it is not even possible to sense the home position. If this failure occurs, the drive motor continues to operate in an attempt to move the scanning unit to the home position, and in so doing the scanning unit bumps into an edge of a base frame of the scanner and makes disturbing mechanical noises. As a result, the scanning operation cannot be performed.

In addition, when using the above-described conventional method of locating the scanning unit by finding the distance from the home position it is also possible to have a system error during the scanning process. In this case, the scanning process abruptly halts and the control unit cannot find the present position of the scanning unit. Therefore, the control unit moves the scanning unit to the home position regardless of where the scanning unit might be located, and the scanning process is resumed.

Unfortunately the control unit does not move the scanning unit to an area where the scanning process (i.e., a prescan process or a double scan process) is actually performed. Instead, the control unit always moves the scanning unit back to the home position. After securing the home position, the control unit measures the relative position of the scanning unit from the home position and performs the scanning process. As such, unnecessary areas are scanned, a scanning speed is reduced, and a cost of the scanning process is wasted.

### SUMMARY OF THE INVENTION

The present general inventive concept provides a scanner that is capable of calculating a precise position of a scanning unit to complement position information obtained based on a number of pulses of a drive motor and transferring the scanning unit to a desired scanning position. The present general inventive concept also provides a method of controlling the position of the scanning unit.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a scanner including: a flat-plate glass having a pattern display in a scanning area thereof, a carriage mounted with a scanning unit to generate image data by reading the scanning area, an actuator to drive the carriage, and a control unit to determine image data that corresponds to the pattern display from among the generated image data of the scanning area, to calculate a position of the scanning unit according to the image data that corresponds to the pattern display, and to control the actuator according to the calculated position.

The control unit may include a position calculating unit to distinguish the image data that corresponds to the pattern display from among the generated image data of the scanning area and to calculate properties of the image data that corresponds to the pattern display such that the control unit calculates the position of the scanning unit based on the calculated image properties of the pattern display.

The pattern display may have a variable width along a movement direction of the carriage.

The variable width of the pattern display may increase along the movement direction of the carriage.

The pattern display may comprise an isosceles triangle shape having a vertex and a base.

The image properties of the pattern display calculated by the position calculating unit may comprise a length of the base of the isosceles triangle-shaped pattern display that corresponds to each position of the carriage.

The control unit may further include a lookup table storage to store a present position of the carriage that corresponds to the length of the base of the triangle-shaped pattern display with respect to a present position of the pattern display that is read in the movement direction of the carriage, and the control unit searches the lookup table storage to determine the present position of the scanning unit.

The pattern display may be attached to a portion of a rear surface of the flat-plate glass, and an image of the pattern display is uniform in color and brightness.

The foregoing and/or other aspects of the present general inventive concept may also be achieved by providing a method of controlling a position of a scanning unit, the method including: reading a scanning area having a pattern display formed on one side thereof and generating image data accordingly, calculating properties of the pattern display based on the generated image data, determining a position of the scanning unit based on the calculated properties of the image data that corresponds to the pattern display, and controlling an actuator to drive the scanning unit and to move the scanning unit to an appropriate position according to the determined position of the scanning unit.

The calculating of the properties may comprise distinguishing image data that corresponds to the pattern display from among the generated image data of the scanning area, and calculating a width of the image data that corresponds to the pattern display.

The method may further include storing a lookup table to provide a present position of the carriage that corresponds to the calculated width of the pattern display with respect to a position along a movement direction of the scanning unit.

The determining of the position of the scanning unit may comprise calculating the width of the pattern display, and comparing the calculated width with that of the lookup table to determine the corresponding position.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is an exploded perspective view illustrating a configuration of a scanner according to an embodiment of the present general inventive concept;

FIG. 2 is a plan view of the scanner of FIG. 1;

FIG. 3 is a schematic block diagram illustrating a scanner according to an embodiment of the present general inventive concept;

FIG. 4 illustrates a pattern display of the scanner of FIG. 2; and

FIG. 5 is a flow chart illustrating a method of controlling a position of a scanning unit in a scanner according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

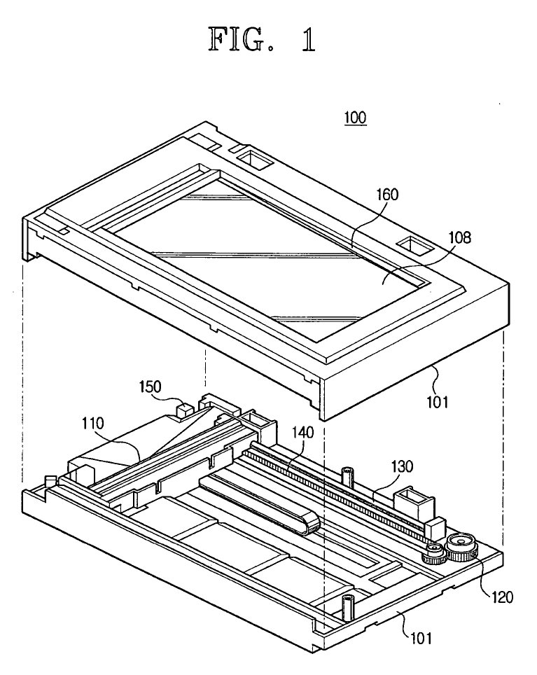

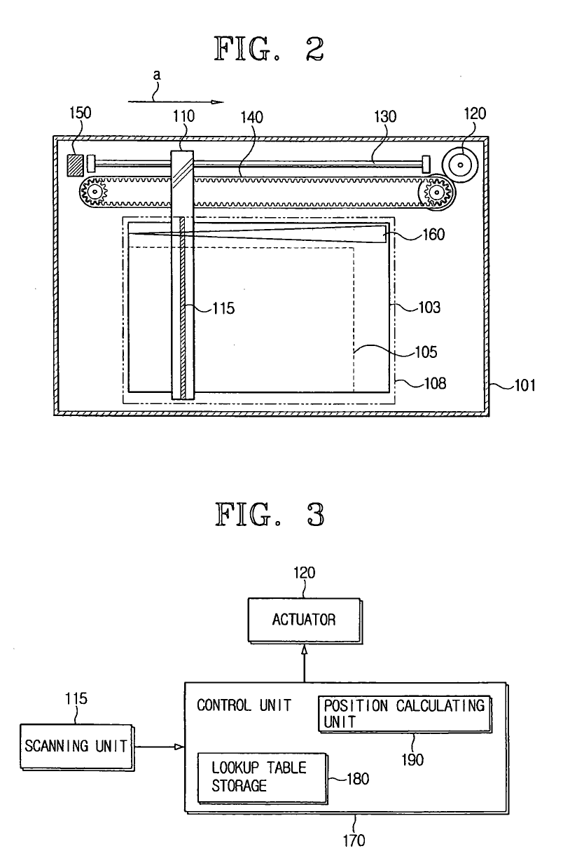

FIG. 1 is an exploded perspective view illustrating a configuration of a scanner 100 according to an embodiment of the present general inventive concept; FIG. 2 is a plan view of the scanner of FIG. 1; FIG. 3 is a schematic block diagram illustrating a scanner including elements to measure a position of a scanning unit according to an embodiment of the present general inventive concept; and FIG. 4 illustrates a pattern display of the scanner of FIG. 1.

Referring to FIGS. 1 to 3, the scanner 100 includes a carriage 110 mounted with a scanning unit 115, a flat-plate glass 108 having a pattern display 160, a home sensor 150, and a control unit 170.

The carriage 110 is driven by a timing belt 140 and an actuator 120 via a carriage shaft 130 within a base frame 101. The home sensor 150 senses the carriage 110 and sends a signal to the control unit 170 to determine that the carriage 110 is located at a home position.

The scanning unit 115 is mounted on the carriage 110. The scanning unit 115 moves in a longitudinal scanning direction (indicated by arrow “a” in FIG. 2) along the carriage shaft 130, irradiates a scan object (e.g., a document to be scanned) while moving, and senses light reflected from the scan object. For explanation purposes, the scan object is herein assumed to be a document, however, it should be understood that other scan objects may also be used. To this end, the scanning unit 115 includes an image sensor, such as a CIS (Contact Image Sensor) or a CCD (Charge Coupled Device), to scan and read a scanning area 103 of the flat-plate glass 108 line by line. A scanned line 107 is illustrated in FIG. 4.

The flat-plate glass 108 is installed on an upper portion of the base frame 101. The flat-plate glass 108 comprises a document area 105 where the document (such as a page) to be scanned is placed, the scanning area 103 formed to contain the document area and having a size that is large enough to surround the document area 105, and a pattern display 160 formed in the scanning area 103 adjacent to the document area 105. It should be understood that in some embodiments of the present general inventive concept the scanning area 103 may not include the document area 105, for example, when the scan object is not a document.

The pattern display 160 is formed on a rear surface of the flat-plate glass 108, more specifically, on a side edge margin of the scanning area 103 outside the document area 105 in such a manner that the pattern display 160 is in parallel with the carriage shaft 130 in the longitudinal scanning direction of the arrow “a.”

Referring to FIG. 4, the pattern display 160 may be triangle shaped. That is, assuming that a reference position used to measure a current position of the carriage 110 corresponds to a vertex of the pattern display 160, a width B of the pattern display 160 increases along the longitudinal scanning direction with distance from the reference position (i.e., the vertex). In the present embodiment, the reference position corresponds to a home position H. In addition, the pattern display 160 exhibits an archromatic color of low brightness such that a portion of scanned image data that corresponds to the pattern display 160 can be easily distinguished from the rest of the scanned image data that corresponds to the document in the document area 105. Additionally, an image of the pattern display 160 is uniform in color and brightness. The pattern display 160 may be an isosceles triangle shape having the vertex on one side of the scanning area 103 that corresponds to the home position H and a base having a designated length on the other side of the scanning area 103 opposite to the home position H. Although the present embodiment describes the pattern display 160 as having a triangular shape, other embodiments of the present general inventive concept may have other shapes that achieve the intended purposes set forth herein. For example, the pattern display 160 may comprise a quadrilateral having a varying width.

The control unit 170 determines a present position of the scanning unit 115, and controls the actuator 120 based on the present position of the scanning unit 115. As illustrated in FIG. 3, the control unit 170 includes a position calculating unit 190 and a lookup table storage 180.

The position calculating unit 190 calculates properties of the scanned image data that corresponds to the pattern display 160 read by the scanning unit 115 such that the control unit 170 can determine the present position of the scanning unit 115. In particular, the position calculating unit 190 calculates the width B of the pattern display 160 that corresponds to a line that is currently read by the scanning unit 115. In other words, the position calculating unit 190 calculates a length of the base of a triangle formed by the line that is currently read and two edges of the pattern display 160. The length of the base of the triangle formed by the line that is currently read and the pattern display 160 can be calculated by distinguishing or isolating pixels that correspond to the pattern display 160, and finding a distance between two pixels 107-1 and 107-2 that correspond to the edges on the both sides of the pattern display 160. The distance between the two pixels 107-1 and 107-2 is equal to the width B of the pattern display 160 that corresponds to the line that is currently read. Here, the distance between two pixels (i.e., B) can be calculated by counting the number of pixels between the two pixels 107-1 and 107-2. Thus, since the width B of the pattern display 160 varies at different positions (i.e., the distance between the edges of the pattern display 160 varies), no two positions along the pattern display 160 have the same width B.

The lookup table storage 180 prestores a lookup table to store lengths of the bases B of the triangle shaped patterns of the pattern display 160, each being measured on the currently read line by the scanning unit 115, and present position values of the carriage 110 in a one-to-one correspondence. The present position values of the carriage 110 are determined by selecting heights opposite the bases of the triangle shaped patterns of the pattern display 160. The heights comprise distances between the vertex of the pattern display 160 and the bases of the triangle shaped patterns. Particularly, the present position value of the carriage 110 stored in the lookup table storage 180 can be referred to as a “present position (h) of the carriage 110.”

Therefore, the lookup table storage 180 stores the lengths of the bases B of the triangle shaped patterns of the pattern display 160, and the present positions (h) of the carriage 110 that correspond to the heights of the triangle shaped patterns of the pattern display 160, respectively, in a one-to-one correspondence. The control unit 170 uses the lookup table storage 180 to calculate the present position (h) of the carriage 110 and to control the position of the scanning unit 115. Accordingly, since the carriage 110 need not be moved to the home position H, an amount of time required to calculate the present position (h) of the carriage 110 can be shortened.

The control unit 170 searches the lookup table storage 180 to calculate the present position (h) of the carriage 110, which corresponds to the length of the base B of the corresponding triangle shaped pattern of the pattern display 160 (i.e., formed by the currently read line 107) provided by the position calculating unit 190, and controls the actuator 120 based on the calculated present position (h) to control the position of the scanning unit 115. Thus, the control unit 170 is able to find the present position (h) of the carriage 110 more easily than in conventional methods simply by searching the lookup table storage 180 to facilitate the position control of the carriage 110 and to move the carriage 110 to the home position H or to another desired position.

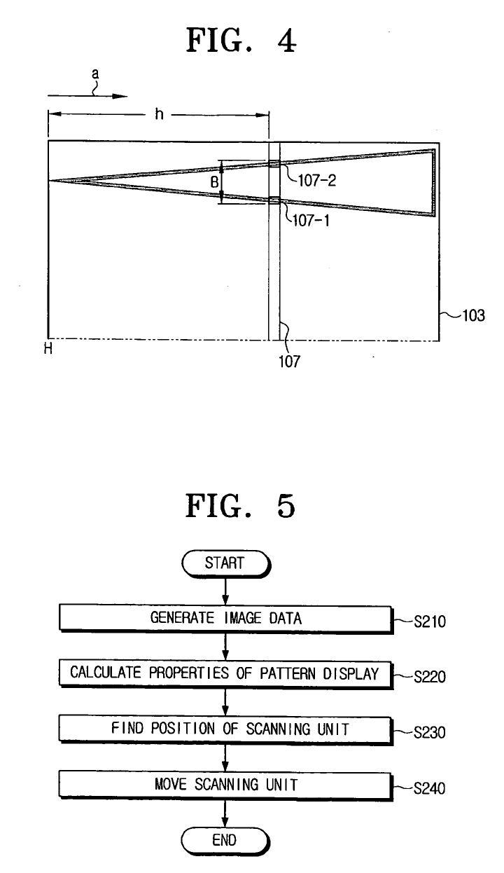

A method of controlling the scanning unit 115 in the scanner 100 according to the present general inventive concept will now be described with reference to FIGS. 1 through 4. FIG. 5 is a flow chart illustrating a method of controlling a position of the scanning unit 115 in a scanner according to an embodiment of the present general inventive concept.

If it is necessary to measure the present position of the scanning unit 115 during the scanning process, the scanning unit 115 scans the line 107 in the scanning area 103 that corresponds to the present position (h) thereof and generates image data from the line 107 (operation S210). For example, it may be necessary to measure the present position (h) of the scanning unit 115 when a system to which the scanner 110 is connected restarts after the system has been stopped or when a particular area designated by a user following a prescanning process is being scanned.

The position calculating unit 190 calculates, based on the image data generated by the scanning unit 115, image properties of the pattern display 160 disposed inside the scanning area 103 (operation S220). As described above, the pattern display unit 160 is formed on the side edge margin of the scanning area 103 that is outside the document area 105. Therefore, once the image data generated by the scanning unit 115 has been read and processed, it becomes easy to distinguish the image data that corresponds to the pattern display 160 from the image data that corresponds to a document that is scanned within the document area 105. Additionally, since the line 107 includes a line portion of the document and a line portion of the pattern display 160, no separate scanning process apart from the scanning of the document is required to scan the pattern display 160.

When the control unit 170 performs signal processing for the image data that corresponds to the scanned line 107, the position calculating unit 190 can calculate the width B (i.e., the length of the base) of the triangle shaped pattern of the pattern display 160 that corresponds to the scanned line 107 from the processed image data. That is, the position calculating unit 190 isolates pixels along the scanned line 107 that correspond to the triangle shaped pattern of the pattern display 160, and determines the distance between two pixels 107-1 and 107-2 that correspond to the edges on the both sides of the triangle shaped pattern of the pattern display 160, which is equal to the width B of the triangle shaped pattern of the pattern display 160.

When the position calculating unit 190 calculates the width B of the triangle shaped pattern of the pattern display 160 that corresponds to the scanned line 107, the control unit 170 searches the lookup table stored in the lookup table storage for the present position (h) of the carriage 110 that corresponds to the distance between the two pixels 107-1 and 107-2 (operation S230). Here, the lookup table may be prestored in the lookup table storage 180 before system initialization.

When the present position (h) of the carriage 110 is determined, the control unit 170 controls the actuator 120 to move the carriage 110 to an appropriate position for the scanning process according to the present position (h) of the carriage 110 (operation S240).

If it is necessary to continue the scanning process from the present position (h) of the scanning unit 115, the carriage 110 does not need to be moved from the present position (h). Otherwise, the carriage 110 can be moved to the home position H or to another desired scanning area that may be designated by the user according to a subsequent scanning process.

Once the carriage 110 is moved to the appropriate position in operation S240, the control unit 170 controls the actuator 120 to move the carriage 110 at a designated speed, and controls the scanning unit 115 mounted on the carriage 110 to perform the scanning process line by line.

The various embodiments of the present general inventive concept make it possible to achieve precise position control of a scanning unit by determining a present position of the scanning unit using a pattern display that is formed inside a scanning area and is distinguishable from a document area in the scanning area, and moving the scanning unit to an appropriate position for a subsequent scanning process.

Moreover, according to the various embodiments of the present general inventive concept, the scanning unit is not required to return to a home position in between each scanning process. Thus, a scanning speed of a variety of functions of a scanner can be increased, and performance of the scanner is substantially improved.

Thus, even when a home sensor fails or produces an inaccurate reading, the scanning process can be performed as normal because a scanning unit, which operates with aid from a pattern display of the various embodiments of the present general inventive concept, is designed to be able to return to a home position regardless of whether the home sensor malfunctions.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A scanner, comprising:
a flat-plate glass having a pattern display in a scanning area thereof;
a carriage mounted with a scanning unit to generate image data by reading the scanning area;
an actuator to drive the carriage; and
a control unit to determine second image data that corresponds to the pattern display from among the generated image data of the scanning area, to calculate a position of the scanning unit according to the image data that corresponds to the pattern display, and to control the actuator according to the calculated position.

2. The scanner according to claim 1, wherein the control unit comprises:
a position calculating unit to distinguish the second image data that corresponds to the pattern display from among the generated image data of the scanning area and to calculate properties of the second image data that corresponds to the pattern display such that the control unit calculates the position of the scanning unit based on the calculated image properties of the pattern display.

3. The scanner according to claim 2, wherein the pattern display has a variable width along a movement direction of the carriage.

4. The scanner according to claim 3, wherein the variable width of the pattern display increases along the movement direction of the carriage.

5. The scanner according to claim 4, wherein the pattern display comprises:
an isosceles triangle shape having a vertex and a base.

6. The scanner according to claim 5, wherein the image properties of the pattern display calculated by the position calculating unit comprise a length of the base of the isosceles triangle-shaped pattern display that corresponds to each position of the carriage.

7. The scanner according to claim 6, wherein the control unit further comprises a lookup table storage to store a present position of the carriage that corresponds to the length of the base of the triangle-shaped pattern display with respect to a present position of the pattern display that is read in the movement direction of the carriage, and the control unit searches the lookup table storage to determine the present position of the scanning unit.

8. The scanner according to claim 2, wherein the pattern display is attached to a portion of a rear surface of the flat-plate glass.

9. The scanner according to claim 8, wherein an image of the pattern display is uniform in color and brightness.

10. A scanner, comprising:
a predetermined pattern disposed along a predetermined direction;
a scanning unit movable along the predetermined direction to produce scan data from the predetermined pattern; and
a control unit to control a position of the scanning unit according to the scan data that corresponds to the predetermined pattern.

11. The scanner according to claim 10, wherein the predetermined pattern has a width that varies along the predetermined direction such that each one of a plurality of positions of the scanning unit along the predetermined direction corresponds to a different width.

12. The scanner according to claim 11, wherein the varying width of the predetermined pattern is defined by two edges, and the control unit determines the current width by counting a number of pixels between the two edges of the predetermined pattern.

13. The scanner according to claim 10, wherein the scanning unit moves between a reference position and a scanning position, and the control unit controls the scanning unit to perform a first scanning process and a second scanning process, determines a current position of the scanning unit from the scan data that corresponds to the predetermined pattern to move the scanning unit from the reference position to the scanning position, and controls the scanning unit to perform the second scanning process without moving the scanning unit to the reference position after the first scanning process.

14. A method of controlling a position of a scanning unit, the method comprising:
reading a scanning area having a pattern display formed on one side thereof, and generating image data accordingly;
calculating one or more properties of the pattern display based on the generated image data;
determining a position of the scanning unit based on the calculated properties of the image data that corresponds to the pattern display; and
controlling an actuator to drive the scanning unit and to move the scanning unit to an appropriate position according to the determined position of the scanning unit.

15. The method according to claim 14, wherein the calculating of the properties comprises:
distinguishing image data that corresponds to the pattern display from among the generated image data of the scanning area; and
calculating a width of the pattern display based on the image data that corresponds to the pattern display.

16. The method according to claim 15, further comprising:
storing a lookup table to provide a present position of the carriage that corresponds to the calculated width of the pattern display with respect to a position along a movement direction of the scanning unit.

17. The method according to claim 16, wherein the determining of the position of the scanning unit comprises:
calculating the width of the pattern display; and
comparing the calculated width with widths in the lookup table to determine the corresponding position of the scanning unit.

18. A method of a scanner having a scanning unit, the method comprising:
scanning a line having a document portion and a pattern portion;
determining a position of the scanning unit according to scan data of the pattern portion of the scanned line; and
controlling the scanning unit according to the determined position.

19. The method according to claim 18, wherein the scanner comprises a scanning area, and the method further comprises:
pre-storing a plurality of different scanning unit positions that correspond to a plurality of pattern portion dimensions that vary along a length of the scanning area perpendicular to scanned line, and
the determining of the position of the scanning unit comprises:
calculating a current dimension of the pattern portion that corresponds to the scanned line; and
determining a scanning unit position that corresponds to the calculated current dimension of the pattern portion.

20. The method according to claim 18, wherein the pattern portion of the scanned line includes image data that is distinguishable from the document portion of the scanned line, and the method further comprises:
distinguishing the image data of the pattern portion from image data that corresponds to the document portion.
